(19) United States
(12) Patent Application Publication
(10) Pub. No.: US 2025/0330601 A1
(43) Pub. Date: Oct. 23, 2025

(54) QUANTIZED EFFICIENT ENCODING FOR STREAMING FREE-VIEWPOINT VIDEOS

(71) Applicant: NVIDIA Corporation, Santa Clara, CA (US)

(72) Inventors: Amrita Mazumdar, Ashbury Park, NJ (US); Tianye Li, Cupertino, CA (US); Shalini De Mello, San Francisco, CA (US); Sharath Girish, College Park, MD (US)

(21) Appl. No.: 19/016,225

(22) Filed: Jan. 10, 2025

Related U.S. Application Data
(60) Provisional application No. 63/637,428, filed on Apr. 23, 2024.
(60) Provisional application No. 63/698,708, filed on Sep. 25, 2024.

(51) Int. Cl. H04N 19/124; G06T 15/20; G06T 17/00; H04N 19/136; H04N 19/167; H04N 19/172; H04N 19/42; H04N 19/463

(52) U.S. Cl. CPC H04N 19/124; G06T 15/20; G06T 17/00; H04N 19/167; H04N 19/172; H04N 19/42; H04N 19/463; G06T 2210/56; H04N 19/136

(57) ABSTRACT

Systems and methods are provided for streaming free-viewpoint videos (FVV) of a dynamic 3D scene. Each time step of the dynamic 3D scene is represented as a set of 3D Gaussians, each 3D Gaussian having a set of Gaussian attributes. Gaussian residuals are encoded for every time step. In at least one embodiment, position residuals are sparsified and non-position attribute residuals are quantized, thereby achieving compression factors without sacrificing reconstruction quality.

### CLAIM OF PRIORITY

This application claims the benefit of U.S. Provisional Application No. 63/637,428, titled “Quantized Streamable Gaussians” and filed Apr. 23, 2024, and of U.S. Provisional Application No. 63/698,708, titled “Quantized Streamable Gaussians” and filed Sep. 25, 2024. The entire contents of both applications are incorporated herein by reference.

### BACKGROUND

Free-viewpoint video (FVV) is a visual media technology that enables a viewer to interactively control the viewpoint from which a captured dynamic scene is observed. FVV receives input videos from each of multiple cameras and provides, for every time step in the input videos, a three-dimensional (3D) scene representation that can be used to render the scene from any viewpoint. FVV thereby enables a viewer to generate new views of a captured scene from arbitrary viewing angles rather than limiting the viewer to a predetermined viewing angle from which the scene was captured.

Streaming FVV in real-time is, however, extremely challenging: large amounts of compute and storage are necessary to encode photorealistic details, but low-latency encoding and decoding are both required to enable streaming and playback in real-time. Furthermore, low data bandwidth is required for transmission via common network infrastructure. Moreover, because streaming FVV in real-time does not permit the luxury of optimizing over an entire video sequence (offline processing), optimization must be conducted on a per-frame basis (online processing).

### BRIEF DESCRIPTION OF THE DRAWINGS

The present systems and methods for quantized efficient encoding for streaming free-viewpoint videos are described in detail below with reference to the attached drawing figures, wherein:

FIG. 1 is a flow diagram illustrating a method for streaming a free-viewpoint video (FVV) to a client device in real time, in accordance with an embodiment;

FIG. 2 is a flow diagram illustrating a method for rendering a free-viewpoint video (FVV) at a client device, in accordance with an embodiment;

FIG. 3A is a block diagram illustrating an example system, according to an embodiment, for serving a free-viewpoint video (FVV) to a client device;

FIG. 3B illustrates the generation of an initial point cloud with and without a depth map, according to an embodiment;

FIG. 3C illustrates a process of generating a 3D representation of a scene corresponding to time t based on a prior 3D representation of the scene corresponding to time t−1, according to an embodiment;

FIG. 3D illustrates use of viewspace gradient differences to identify dynamic scene content, initialize gate parameters, and support localized training, according to an embodiment;

FIG. 3E illustrates, according to an embodiment, gate values before and after training;

FIG. 3F illustrates the use of quantized integer latents and a shared linear decoder to generate floating point residual values, according to an embodiment;

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

The present disclosure provides systems and methods for efficient encoding for streaming free-viewpoint videos (FVV) of dynamic 3D scenes. The present disclosure provides systems and methods that represent each time step of a dynamic 3D scene as a set of 3D Gaussians and that model residuals for all Gaussian attributes, thereby providing improved quality as compared to state-of-the-art techniques. The present disclosure further provides systems and methods that learn to directly compress Gaussian residuals in proportion to real-time scene dynamics, e.g., motion and illumination changes, thereby providing higher efficiency in terms of model size, as well as training and rendering speeds. The present disclosure also provides systems and methods that exploit redundancies across time-steps to limit encoding computations to only dynamic portions of the scene, thereby achieving further efficiencies.

According to various embodiments, the present disclosure provides systems and methods that create a 4D representation of a dynamic scene by creating an initial 3D representation, in the form of a set of 3D Gaussians, corresponding to an initial time step and generating, using a dual quantization-sparsity pipeline, residuals for updating the set of Gaussians at each subsequent time step. In various embodiments, the systems and methods quantize all Gaussian attribute residuals-except Gaussian positions-via an end-to-end trainable integer-based latent-decoder and sparsify Gaussian position residuals via a gating mechanism that differentiates between static and dynamic Gaussians. Once learned, the integer latents and sparse position residuals can be efficiently encoded via entropy coding and sparse matrix formats to achieve high compression factors. In various embodiments, systems and methods utilize differences between the 2D viewspace Gaussian gradients of consecutive frames to initialize learnable gates and to selectively render local image regions corresponding to highly dynamic scene content, thereby achieving further efficiencies in terms of training time and storage. On various challenging real-world dynamic scenes, embodiments of the present disclosure have been demonstrated to surpass existing state-of-the-art approaches on metrics including reconstruction quality, memory utilization, and both training and rendering speeds.

According to a first aspect, a method is provided for encoding a free-viewpoint video (FVV). The method includes receiving, as input, a first multi-view frame of a scene corresponding to a first time and generating, based on the first multi-view frame, a plurality of three-dimensional (3D) Gaussians that collectively represent the scene at the first time. Each 3D Gaussian includes a position attribute and one or more non-position attributes. The method further includes receiving, as further input, a second multi-view frame of the scene corresponding to a second time and determining, for each 3D Gaussian of the plurality of 3D Gaussians, a position residual and one or more non-position residuals. Determining the position and non-position residuals includes modeling the position residuals using a sparsity framework, modeling the non-position residuals using a quantization framework, and learning the position residuals and the non-position residuals using machine learning techniques.

In at least one embodiment, modeling the position residuals using the sparsity framework includes representing each position residual as a product of a learnable gate and a learnable full-precision position residual. In at least one embodiment, modeling the position residuals using the sparsity framework further includes initializing parameters of each learnable gate based on a score vector computed, at least in part, from a gradient of a reconstruction loss with respect to a position of a corresponding Gaussian at the second time and a gradient of a reconstruction loss with respect to a position of the corresponding Gaussian at the first time.

In at least one embodiment, modeling the non-position residuals using the quantization framework includes representing each non-position residual as a product of a learnable integer latent and a learnable codebook. In at least one embodiment, the one or more non-position attributes include a rotation attribute, a scale attribute, an opacity attribute, and/or a color attribute, and the one or more non-position residuals include a rotation residual, a scale residual, an opacity residual, and/or a color residual. In at least one embodiment, each respective rotation residual is modeled as a product of a corresponding respective rotation integer latent and a common rotation codebook, each respective scale residual is modeled as a product of a corresponding respective scale integer latent and a common scale codebook, each respective opacity residual is modeled as a product of a corresponding respective opacity integer latent and a common opacity codebook, and each respective color residual is modeled as a product of a corresponding respective color integer latent and a common color codebook.

In at least one embodiment, learning the position residuals and the non-position residuals using machine learning techniques includes rendering, during a forward pass, an output image corresponding to a viewpoint from which a respective image of the second multi-view frame was captured, the rendering being performed using the position attributes, the non-position attributes, learnable position residuals, and learnable non-position residuals. The learning the position residuals using machine learning techniques further includes computing a loss by comparing the output image to the respective image of the second multi-view frame, calculating, during a backward pass, gradients of the computed loss with respect to the learnable position residuals and the learnable non-position residuals, and updating the learnable position residuals and the learnable non-position residuals based on the calculated gradients. In at least one embodiment, the loss includes a reconstruction loss and a regularization loss. The reconstruction loss measures a difference between the output image and the respective image of the second multi-view frame, and the regularization loss decreases as the sparsity of the learnable position residuals increases. In at least one embodiment, the learning the position residuals and the non-position residuals further includes defining, for the respective image of the second multi-view frame, static and dynamic regions, and the rendering the output image is performed only for the dynamic regions of the respective image of the second multi-view frame.

In at least one embodiment, the method further includes generating, based on the first multi-view frame, a point cloud, wherein the point cloud is generated using a structure-from-motion algorithm and enhanced using depth map provided via monocular depth estimation.

According to a second aspect, a system is provided for encoding a free-viewpoint video (FVV). The system includes processing circuitry configured to receive, as input, a first multi-view frame of a scene corresponding to a first time and generate, based on the first multi-view frame, a plurality of three-dimensional (3D) Gaussians that collectively represent the scene at the first time. Each 3D Gaussian includes a position attribute and one or more non-position attributes. The processing circuitry is further configured to receive, as further input, a second multi-view frame of the scene corresponding to a second time, and determine, for each 3D Gaussian of the plurality of 3D Gaussians, a position residual and one or more non-position residuals. The processing circuitry is configured to determine the position residuals and the non-position residuals by modeling the position residuals using a sparsity framework, modeling the non-position residuals using a quantization framework, and learning the position residuals and the non-position residuals using machine learning techniques. The system further includes one or more memories configured to store the first multi-view frame, the plurality of 3D Gaussians, the second multi-view frame, and the position residuals and the non-position residuals.

In at least one embodiment, the processing circuitry is configured to model the position residuals using the sparsity framework by representing each position residual as a product of a learnable gate and a learnable full-precision position residual. In at least one embodiment, the processing circuitry is configured to model the position residuals using the sparsity framework by further initializing parameters of each learnable gate based on a score vector computed, at least in part, from a gradient of a reconstruction loss with respect to a position of a corresponding Gaussian at the second time and a gradient of a reconstruction loss with respect to a position of the corresponding Gaussian at the first time.

In at least one embodiment, the processing circuitry is configured to model the non-position residuals using the quantization framework by representing each non-position residual as a product of a learnable integer latent and a learnable codebook. In at least one embodiment, the one or more non-position attributes include a rotation attribute, a scale attribute, an opacity attribute, and/or a color attribute, and the one or more non-position residuals include a rotation residual, a scale residual, an opacity residual, and/or a color residual. In at least one embodiment, the processing circuitry is configured to model each respective rotation residual as a product of a corresponding respective rotation integer latent and a common rotation codebook, model each respective scale residual as a product of a corresponding respective scale integer latent and a common scale codebook, model each respective opacity residual as a product of a corresponding respective opacity integer latent and a common opacity codebook, and model each respective color residual as a product of a corresponding respective color integer latent and a common color codebook.

In at least one embodiment, the processing circuitry is configured to learn the position residuals and the non-position residuals using machine learning techniques by rendering, during a forward pass, an output image corresponding to a viewpoint from which a respective image of the second multi-view frame was captured, the rendering being performed using the position attributes, the non-position attributes, learnable position residuals, and learnable non-position residuals. The processing circuitry is configured to learn the position residuals and the non-position residuals using machine learning techniques by further computing a loss by comparing the output image to the respective image of the second multi-view frame, calculating, during a backward pass, gradients of the computed loss with respect to the learnable position residuals and the learnable non-position residuals, and updating the learnable position residuals and the learnable non-position residuals based on the calculated gradients. In at least one embodiment, the loss includes a reconstruction loss and a regularization loss. The reconstruction loss measures a difference between the output image and the respective image of the second multi-view frame, and the regularization loss decreases as the sparsity of the learnable position residuals increases.

In at least one embodiment, the processing circuitry is further configured to learn the position residuals and the non-position residuals by defining, for the respective image of the second multi-view frame, static and dynamic regions, and the rendering the output image is performed only for the dynamic regions of the respective image of the second multi-view frame.

In at least one embodiment, the processing circuitry is further configured to generate, based on the first multi-view frame, a point cloud, wherein the point cloud is generated using a structure-from-motion algorithm and enhanced using depth map provided via monocular depth estimation.

According to a third aspect, a non-transitory computer-readable media stores processor-executable instructions for encoding a free-viewpoint video (FVV) that, when executed by processing circuitry, cause the processing circuitry to perform the method according to the first aspect, including any embodiment thereof.

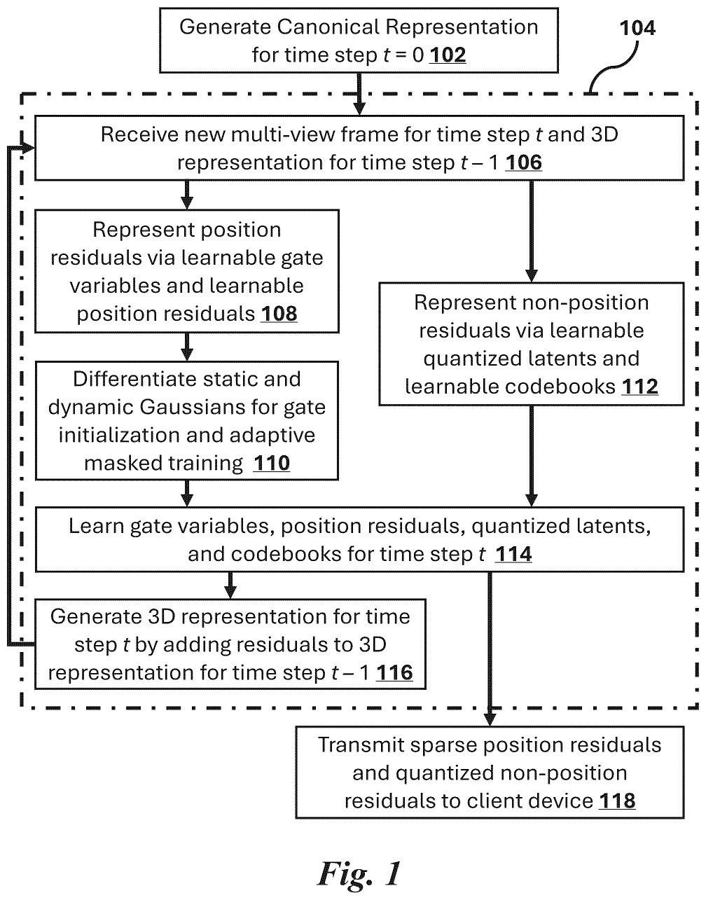

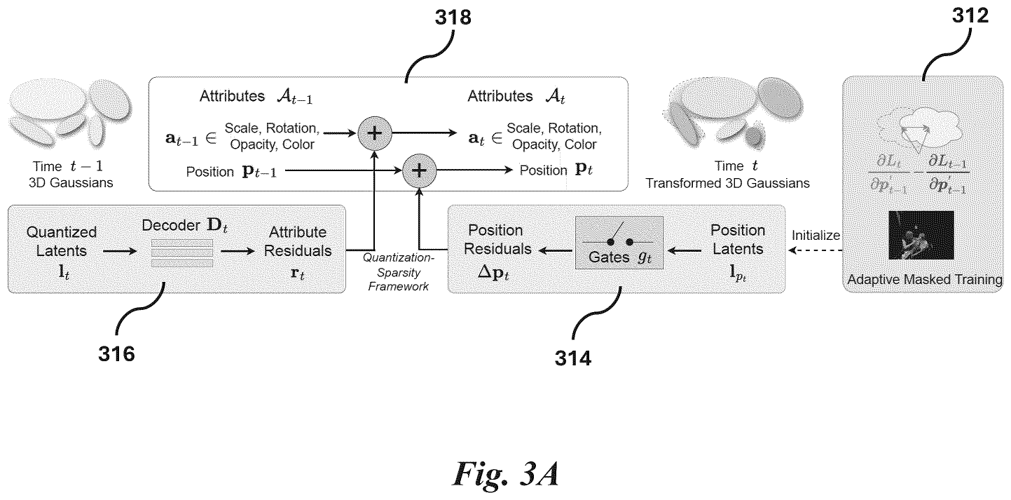

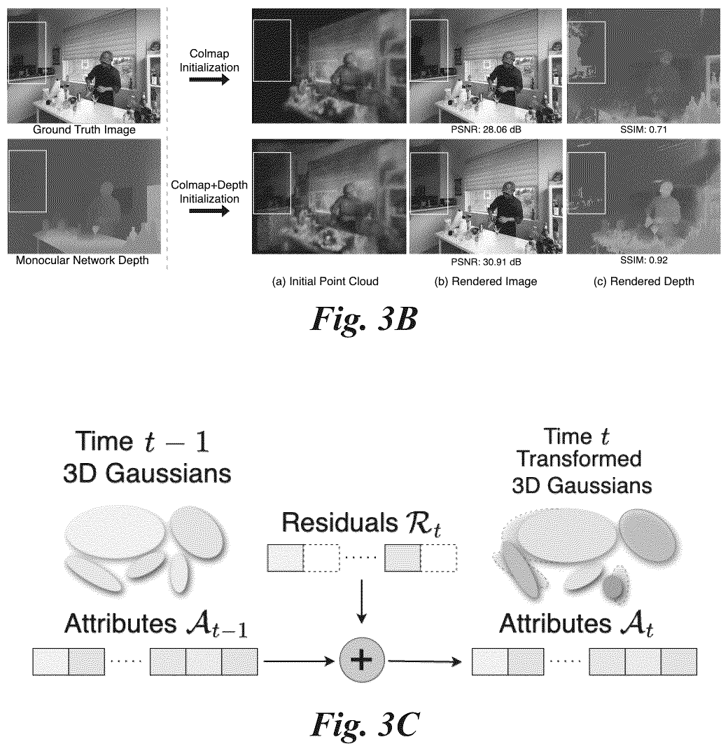

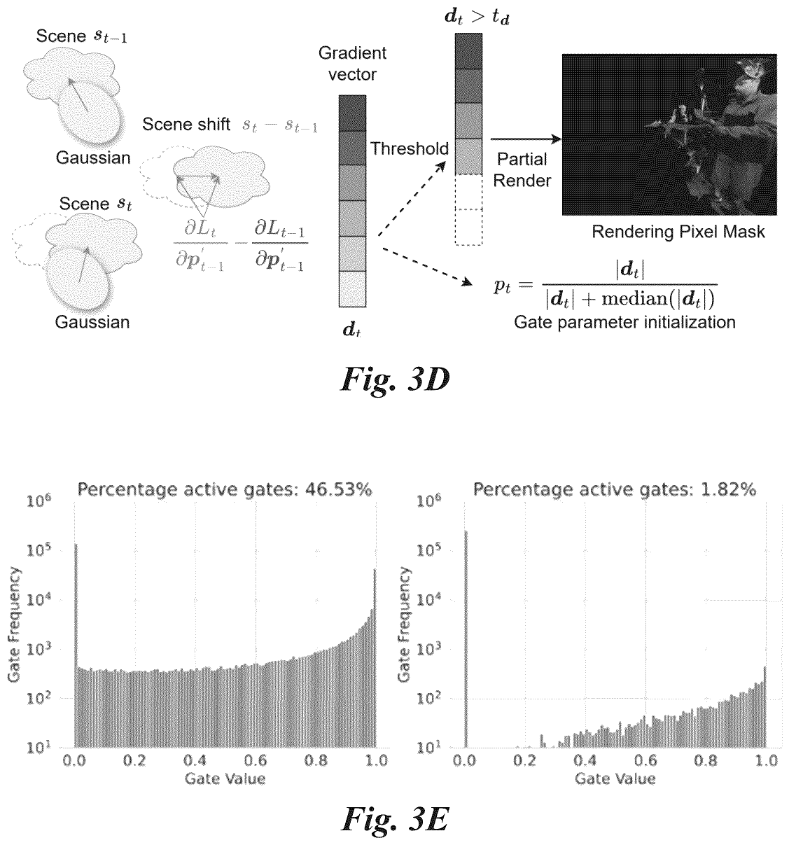

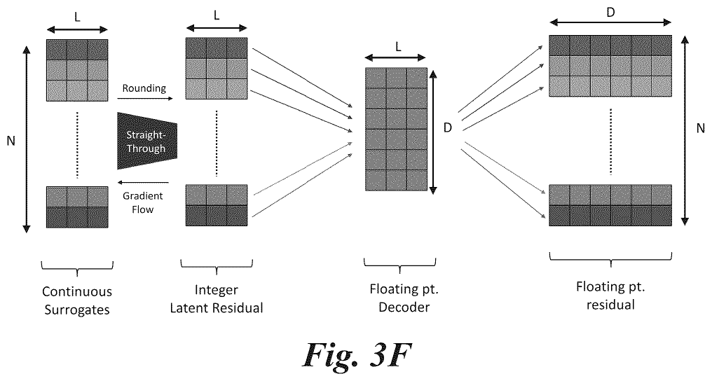

FIG. 1 is a flow diagram illustrating a method 100 for streaming a free-viewpoint video (FVV) to a client device in real time, in accordance with an embodiment. Each block of method 100, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 100 is described, by way of example, with respect to the system of FIG. 3A. However, this method may additionally or alternatively be executed by any one system, or any combination of systems, including, but not limited to, those described herein. Furthermore, persons of ordinary skill in the art will understand that any system that performs method 100 is within the scope and spirit of embodiments of the present disclosure.

The method 100 utilizes a dual quantization-sparsity pipeline to generate residuals used for updating, at each of a plurality of time steps, a set of 3D Gaussians that form a 3D representation of a scene. The method 100 involves, at 102, generating a canonical 3D representation of a dynamic scene in the form of a set of 3D Gaussians. The canonical 3D representation is generated using a multi-view frame, which includes a plurality of images, for a time step t=0. Each of the plurality of images of the multi-view frame is from unique viewpoint at time t=0.

In at least one embodiment, the 3D Gaussians that represent the scene are initialized at 102 using an initial 3D point cloud generated via a 3D reconstruction tool that utilizes a structure-from-motion algorithm. In at least one embodiment, the 3D reconstruction tool is COLMAP. The structure-from-motion algorithm receives, as input, the plurality of images of the multi-view frame. The initial point cloud is used to initialize a set of 3D Gaussians that models the scene at time t=0.

In at least one embodiment, method 100 further involves utilizing depth maps to enhance the initial point cloud generated via the 3D reconstruction tool. A well-constructed initial 3D representation of the scene (i.e. the canonical representation generated at 102) facilitates a high-quality FVV, particularly for an incrementally updating online streaming approach. However, the construction of the initial 3D representation can be compromised due to regions of the scene that are sparsely represented by camera views in the multi-view frame being sparsely represented in the initial point cloud. To enhance the construction of the initial 3D representation, an off-the-shelf monocular depth estimation network is used, according to at least one embodiment, to estimate point locations in such regions and thereby provide a more complete initial point cloud. Due to the scale-shift ambiguity of monocular depth estimation, the predicted monocular depth is aligned with the true scene depth from existing point cloud points.

In at least one embodiment, 2D pixel locations

$${p}_{i}^{′}$$

of each point cloud point i are estimated by projecting points from the 3D representation space to 2D viewspace using

$${p}_{i}^{′} = \prod ( {p}_{i} ; K , W ) ,$$

where Π(⋅) denotes the perspective projection, K is the intrinsic matrix corresponding to the view, and W is the viewing transform. The pixel locations pᵢ′ are queried in the monocular depth image to obtain the corresponding depth values \hat{z}ᵢ. These depth values \hat{z}ᵢ are aligned with the ground truth depth values from the 3D point cloud points zᵢ by a least-squares optimization to obtain the scale and shift parameters α,β for providing an aligned dense depth map α\hat{z}ᵢ+β. To identify regions sparsely represented in the initial point cloud, renderings corresponding to each image of the multi-view frame are produced along with an alpha mask calculating the accumulated transmittance at each pixel location. Mask values below a threshold t_{z} are identified to obtain pixel locations containing few point cloud points, and the aligned depth values corresponding to these pixel locations are re-projected back into the 3D representation space.

FIG. 3B illustrates the generation, via COLMAP, of an initial point cloud without (top row) and with (bottom row) depth maps predicted by a monocular depth estimation network. The COLMAP initialization produces a sparse point cloud for the regions of the scene with limited texture (one or which is identified by the box on the left-hand side of the image), leading to erroneous image rendering and incorrect scene geometry/depth. The addition of the monocular depth estimation network improves both the quality of the rendered image (peak signal-to-noise ratio (PSNR) increases from 28.06 dB to 30.91 dB) and the scene geometry (the structural similarity index measure (SSIM) increases from 0.71 to 0.92).

Each 3D Gaussian of the set of 3D Gaussians that forms the 3D representation of the scene has a set of learned attributes [symbol] . In at least one embodiment, the set of learned attributes [symbol] includes an attribute for position (pᵢ), an attribute for rotation (qᵢ), an attribute for scale (sᵢ), an attribute for opacity (oᵢ), and an attribute for color (hᵢ). In at least one embodiment, the shape of each Gaussian i is defined by its position, or mean, pᵢ∈ [symbol] ³ and covariance matrix Σᵢ. The covariance matrix is represented by

$${\sum }_{i} = {R}_{i} {S}_{i} {S}_{i}^{T} {R}_{i}^{T} ,$$

where Rᵢ is a rotation matrix parameterized by a quaternion vector qᵢ∈ [symbol] ⁴ and Sᵢ is a diagonal scale matrix with elements sᵢ∈ [symbol] ². Each Gaussian also contains opacity oᵢ∈[0,1] and spherical harmonic coefficients hᵢ for view-dependent appearance with dimensions based on the number of degrees.

The set of 3D Gaussians that forms the 3D representation of the scene can be utilized to render a 2D view of the scene from any desired viewpoint by projecting the set of 3D Gaussians into 2D Gaussians corresponding to the desired viewpoint. In at least one embodiment, for a 2D view of the scene corresponding to a camera with intrinsic matrix K and viewing transform W, the 2D mean and covariance are

$${p}_{i}^{′} = \prod ( {p}_{i} ; K , W ) and {\sum }_{i}^{′} = JW {\sum }_{i} {W}^{T} {J}^{T} ,$$

where Π(⋅) denotes the perspective projection and J is the Jacobian of the affine approximation of the projective transform. The image color ĉ at pixel location x is obtained by blending N depth-sorted 3D Gaussians with their view-dependent RGB color value cᵢ computed from hᵢ:

$$\hat{c} ( x ) = {\sum }_{i = 1}^{N} {c}_{i} {α}_{i} {\prod }_{j = 1}^{i - 1} ( 1 - {α}_{j} ) ,$$

where:

$${α}_{i} = {0}_{i} \cdot exp ( - \frac{1}{2} {( x - {p}_{i}^{′} )}^{T} {\sum }_{i}^{′ - 1} ( x - {p}_{i}^{′} ) ) ,$$

where αᵢ is the conic opacity of Gaussian i at pixel location x multiplied by the Gaussian opacity oᵢ.

To generate the canonical representation at 102, the attributes of each 3D Gaussian in the set of 3D Gaussians are learned via a machine learning technique in which an initial set of 3D Gaussians are refined over a number of iterations until an optimization criteria is satisfied. First, the initial set of 3D Gaussians is used to generate a rendering, e.g. via rasterization, in a forward pass. The rendering corresponds to a unique viewpoint from which an image of the multi-view frame was captured. Thereafter, a reconstruction loss is computed by comparing the rendering with the corresponding image of the multi-view frame, gradients of the computed reconstruction loss are backpropagated to the attributes of the 3D Gaussians, and the attributes are updated based on the backpropagated gradients. A new rendering is then generated using the updated attributes, and the process is repeated over a number of iterations until the optimization criteria is satisfied. In at least one embodiment, a first rendering corresponding to a first image of the multi-view frame is used to optimize the Gaussian attributes for a first training epoch, and one or more additional renderings corresponding to one or more additional images of the multi-view frame are used to optimize the Gaussian attributes for one or more additional training epochs. In at least one embodiment, training is performed with only a subset of the images of the multi-view frame, and at least one image of the multi-view frame is reserved as a test image (which can subsequently utilized to evaluate method 100 on an “unseen” view).

In at least one embodiment, during generation of the canonical representation at 102, a differentiable rasterizer is employed to produce renderings [symbol] =R( [symbol] ) based on attributes

$$𝒜 = {\{ {p}_{i} , {q}_{i} , {s}_{i} , {o}_{i} , {h}_{i} \}}_{i = 1}^{N} of N 3 D$$

Gaussians that make up the set of 3D Gaussians that represent the scene. The attributes are learned by optimizing a reconstruction loss to fit the renderings R(A) to input images [symbol] (i.e. images of the multi-view frame for time t=0). In at least one embodiment, the reconstruction loss combines a D-SSIM loss (i.e. the structural dissimilarity loss derived from the structural similarity index (SSIM)) and L₁ loss with a hyperparameter k L=λL_{D-SSIM}+(1−λ)L₁.

Once the canonical 3D representation is generated at 102, the method 100 performs—for every subsequent multi-view frame that is received (i.e. for each time step t>0—an encoding process 104 via which Gaussian residuals are determined. The Gaussian residuals are updates to the Gaussian attributes (corresponding to a prior time step t−1) necessary to update the 3D representation so that it accurately represents the scene at the current time step t. In at least one embodiment, a dynamic scene corresponding to a multi-view image sequence

$${\{ {𝒥}_{t} \}}_{t = 0}^{T - 1}$$

reconstructed as a set of 3D Gaussians with, for each time-step t, attributes [symbol] ₜ= [symbol] ₜ₋₁+ [symbol] ₜ, where [symbol] ₜ₋₁ are attributes for time-step t−1 and [symbol] ₜ are learned residuals for each attribute. For time-step t=0, attributes [symbol] _{D} are the attributes of the canonical representation generated at 102. Thereafter, for every time step t>0, residuals [symbol] ₜ are determined, i.e. learned, on-the-fly with incoming streaming training views.

FIG. 3C illustrates a process of generating a 3D representation of a scene corresponding to time t based on a prior 3D representation of the scene corresponding to time t−1. At time t−1, the scene is represented by a set of 3D Gaussians having attributes

$${𝒜}_{t - 1} = {\{ {p}_{i}^{t - 1} , {q}_{i}^{t - 1} , {s}_{i}^{t - 1} , {o}_{i}^{t - 1} , {h}_{i}^{t - 1} \}}_{i = 1}^{N} .$$

At time t, the scene is represented by a set of 3D Gaussians having attributes

$${𝒜}_{t} = {\{ {p}_{i}^{t} , {q}_{i}^{t} , {s}_{i}^{t} , {o}_{i}^{t} , {h}_{i}^{t} \}}_{i = 1}^{N} .$$

To generate the 3D representation of the scene at time t, residuals

$${ℛ}_{t} = {\{ Δ {p}_{i}^{t} , Δ {q}_{i}^{t} , Δ {s}_{i}^{t} , Δ {o}_{i}^{t} , Δ {h}_{i}^{t} \}}_{i = 1}^{N}$$

are provided such that [symbol] ₜ= [symbol] ₜ₋₁+ [symbol] ₜ.

The encoding process 104 begins by receiving, at 106, a new multi-view frame for the time step t. The new multi-view frame includes a plurality of images, each respective image captured from a corresponding unique viewpoint. The unique viewpoints at each time step t are the same as the unique viewpoints from which the images of the multi-view frame are captured for the time step t=0. However, in at least one embodiment, the unique viewpoints at a time step t include one or more unique viewpoints that are different from the unique viewpoints for the time step t=0 or for a time step t′<t. In such an embodiment, a precise position and orientation of the unique viewpoints at the time step t are necessary to provide accurate attribute residuals.

As previously noted, real-time FVV streaming requires encoding sufficient data to provide photorealistic details while simultaneously providing low-latency encoding and low data bandwidth, i.e. for storage and transmission. The sequential formulation provided by the method 100 allows a 4D scene to be represented solely from a canonical representation at time step t=0 and from sets of residuals for each subsequent time step t>0. As the residuals have low magnitudes compared to the attributes themselves, high compression performance is achieved. However, representing the 4D scene with uncompressed residuals is still highly inefficient, as the residuals can be efficiently compressed. To efficiently compress all residuals, the encoding process 104 implements a dual quantization-sparsity pipeline: position residuals are modeled using a sparsity framework (i.e. compressed through sparsity), while other attribute residuals are modeled using a quantization framework (i.e. compressed through quantization). The combination of the sequential formulation and the quantization-sparsity framework enables a 4D scene to be represented solely through compressed residuals, providing substantial performance improvements as compared to state-of-the art techniques.

After receiving the new multi-view frame for the time step t at 106, the encoding process 104 proceeds to model position residuals using a sparsity framework at 108 through 110 and to model other attribute residuals using a quantization framework at 112, thereby providing compressed Gaussian residuals necessary to update the Gaussian attributes corresponding to a prior time step t−1 in order to yield Gaussian attributes that accurately represent the 3D scene at the current time step t.

The present disclosure has recognized that position residuals are sensitive to quantization and require high precision during rendering. However, storing all full-precision position residuals results in high per-frame memory costs. Furthermore, the present disclosure has also recognized that real-world dynamic scenes often contain high amounts of temporal redundancy with only a fraction of the content changing between consecutive time-steps t−1 and t. The sparsity framework at 108 through 110 identifies Gaussians corresponding to static scene content and sets their residuals to 0 while simultaneously maintaining full-precision, non-zero values for the remaining position residuals, thereby attaining high compression performance by enforcing sparsity instead of quantization. In method 100, position residuals are determined by modeling, at 108, each position residual as the product of a learnable gate and a learnable, full-precision position residual and then learning the gates and the full-precision position residuals. After training, the sparse position residual can be efficiently stored via sparse matrix formats to reduce memory costs.

In at least one embodiment, the position residuals for each Gaussian i are modeled, at 108, as Δpᵢ=gᵢ·lₚᵢ, where pᵢ is the position, or mean, or the ith Gaussian, gᵢ is a learnable gate parameter, and lₚᵢ∈ [symbol] ³ is a learnable pre-gated residual in full precision during training. During training, parameters of the gates and the full precision position residuals are learned simultaneously. Differentiable training of the gates is enabled by modeling a discrete Bernoulli gate using a differentiable hard concrete gate. For each Gaussian i, a concrete gate is a continuous relaxation of the Bernoulli distribution ĝᵢ=Sigmoid(log αᵢ/τ), where αᵢ is a learnable parameter and i is a temperature hyperparameter. Although the concrete gate approximates the discrete Bernoulli gate, it does not include the end points {0, 1}, and therefore, doesn't directly result in sparsity. The hard concrete gate “stretches” the range of the concrete gate to the interval (γ₀, γ₁) and then applies a hard-sigmoid: \tilde{g}ᵢ=ĝᵢ·(γ₁−γ₀)+γ₀. The learnable gate parameter gᵢ is determined as gᵢ=min(1, max(0, \tilde{g}ᵢ)), which includes end points {0, 1} for gᵢ to provide sparse residuals. The hard concrete gate formulation leads to a convenient regularization loss for encouraging L₀ sparsity in the gates gᵢ:

$${L}_{reg} = {\sum }_{i = 1}^{N} {p}_{i} = {\sum }_{i = 1}^{N} Sigmoid ( log {α}_{i} - τ log \frac{- {γ}_{0}}{{γ}_{1}} ) .$$

In alternative embodiments, the learnable gate parameters gᵢ can be learned via an L₁ regularization loss. During each iteration of encoding process 104, an optimization algorithm is employed to simultaneously minimize both: (i) a reconstruction loss that measures the difference between (a) the images of the multi-view frame for the time step t, received at 106, and (b) renderings generated using a set of 3D Gaussians having attributes [symbol] ₜ determined from learnable residuals [symbol] ₜ—which include the learnable sparse position residuals Δpᵢ=gᵢ·lₚᵢ; and (ii) the regularization loss, which decreases as the sparsity of the position residuals increases. After training, the learned sparse position residuals Δpᵢ can be efficiently stored via sparse matrix formats to reduce memory costs and bandwidth requirements during transmission.

In order to increase the efficiency of the computational processes employed to learn the sparse position residuals and thereby decrease encoding latency, the encoding process 104 differentiates, at 110, static Gaussians from dynamic Gaussians for gate initialization and adaptive masked training. In at least one embodiment, the encoding process 104 computes, for each image pair in the multi-view frames for time steps t−1 and t (e.g. for each pair of one image from time step t−1 acquired from a particular viewpoint and one image from time step t acquired from the same viewpoint), gradients of a reconstruction loss with respect to the position attribute (i.e. Gaussian mean) for each Gaussian. A score vector—which is the average of the gradient differences across all training views—is computed to differentiate between static and dynamic Gaussians. In at least one embodiment, the score vector dₜ, which is the average of gradient differences across all training views v, is computed as:

$${d}_{t} = \frac{1}{V} {\sum }_{v = 0}^{V - 1} [ \frac{\partial {L}_{t}^{( v )}}{\partial {p}_{t - 1}^{′ ( v )}} - \frac{\partial {L}_{t - 1}^{( v )}}{\partial {p}_{t - 1}^{′ ( v )}} ] ,$$

where

$${L}_{t - 1}^{( v )} = L ( {𝒥}_{t - 1}^{( v )} , {\hat{𝒥}}_{t - 1}^{( v )} )$$

is the MSE reconstruction loss between the ground truth image ( [symbol] ) and the rendered image ( [symbol] ) for time step t−1, and where

$${L}_{t}^{( v )} = L ( {𝒥}_{t}^{( v )} , {𝒥}_{t - 1}^{( v )} )$$

is the MSE reconstruction loss between the ground truth image ( [symbol] ) for time step t and the ground truth image ( [symbol] ) for time step t−1. The score vector dₜ identifies dynamic scene regions while factoring out noise from imperfect reconstructions at time-step t−1.

In at least one embodiment, the gate parameters of the learnable position residuals are initialized based on the score vector. In at least one embodiment, the norm of the score vector |dₜ_{ᵢ}|, is used to initialize the gate parameters gᵢ of the learnable position residuals Δpᵢ=gᵢ·lₚᵢ. In at least one embodiment, the probability of a gate being active for Gaussian i at time-step t is

$${d}_{{t}_{i}} = \frac{\vert {d}_{{t}_{i}} \vert}{\vert {d}_{{t}_{i}} \vert + {median}_{i = 1 , 2 , … , N} ( \vert {d}_{{t}_{i}} \vert )} ,$$

and the gates gᵢ=min(1, max(0, Sigmoid(log α₁/τ)·(γ₁−γ₀)+γ₀)) are initialized with αᵢ that solve

$${\sum }_{i = 1}^{N} {d}_{{t}_{i}} = {\sum }_{i = 1}^{N}$$

### Sigmoid

$$( log {α}_{i} - τ log \frac{- {γ}_{0}}{{γ}_{1}} ) .$$

Initializing gate parameters of the learnable position residuals based on the score vector leads to better convergence by identifying static Gaussians at the start of training itself, allowing the encoding process 104 to avoid initializing all gate parameters as “1” (which would require more iterations for convergence) and to avoid performing, during the process of learning the sparse position residuals, unnecessary forward/backward passes through static regions of the scene (which would amount to wasted training computation).

In at least one embodiment, the score vectors dₜ are utilized for an adaptive masked training scheme. Each ith Gaussian is identified as either static or dynamic by comparing the norm of the score value dₜ, to a threshold t_{d}. Then, during training at 114, only regions that correspond to dynamic image regions of the ground truth images are rendered, and residual parameters are learned by optimizing a reconstruction loss that considers only the dynamic image regions of the ground truth images. In at least one embodiment, such masked training is performed for a fraction of the full training iterations to improve training speeds with little to no loss of reconstruction quality.

FIG. 3D illustrates use of viewspace gradient differences to identify dynamic scene content, initialize gate parameters, and support localized training to accelerate the encoding process 104. As a result of a scene shift sₜ−sₜ₋₁ from time step t−1 to time step t, the score vector dₜ_{ᵢ} identifies dynamic scene regions, and the probabilities of gates being active at time-step t (derived from norms of the score vectors), is used to initialize the gates prior to training. Furthermore, during training, only regions of the scene that correspond to dynamic regions of the ground truth image (as indicated by dₜ_{ᵢ}>t_{d}) are rendered, thereby improving training speed. FIG. 3E illustrates, according to one example, gate values before and after training that result from initializing gate parameters of the learnable position residuals based on the score vector. During training, the percentage of active gates dropped from 46.53% to 1.82%—representing a substantial decrease in the memory/bandwidth requirements for streaming FVV attributable to the sparsity framework employed by method 100.

With respect to the non-position attributes, the method 100 implements a quantization framework at 112. Specifically, residuals for non-position attributes are determined, for each time step t by encoding process 104, by modeling, at 112, each residual as the product of a learnable integer latent and a learnable codebook (i.e. a shared compact decoder) and then learning the integer latents and codebooks. Unique codebooks are maintained for each attribute (i.e. scale, rotation, opacity, color base, and color higher order), and a new set of codebooks is learned at each time-step/frame. To allow learning of the integer latents and the codebooks via a differentiable training process, continuous approximations of the integer latents are used to allow for gradient optimization. During each forward pass of the training process, the continuous approximations are rounded to the nearest integer values, and during each backward pass, gradients are propagated to the continuous approximations via the Straight-Through Estimator.

In at least one embodiment, at each time-step t, the residuals rᵢ∈ [symbol] ^{M} for each category (i.e. rotation, scale, opacity and color) are represented as the product of learnable quantized integer latents lᵢ∈ [symbol] ^{L} for each ith Gaussian and a shared linear decoder D with learnable parameters D∈ [symbol] ^{M×L}. The shared linear decoders are able to leverage spatial [symbol] redundancy that results from nearby Gaussians typically having highly correlated residuals for shape, orientation and appearance. During each iteration of encoding process 104, an optimization algorithm is employed to minimize a reconstruction loss that measures the difference between (a) the images of the multi-view frame for the time step t, received at 106, and (b) renderings generated using a set of 3D Gaussians having attributes [symbol] ₜ determined from learnable residuals [symbol] ₜ—which include the learnable non-position residuals rᵢ=D(lᵢ; D)=D·float(lᵢ). To learn the residuals rᵢ, continuous latents \hat{l}ᵢ∈ [symbol] ^{L} are rounded to nearest integer values during the forward pass to provide quantized integer latents lᵢ, and gradients are backpropagated to the continuous latents \hat{l}ᵢ via the Straight-Through Estimator (STE). The STE allows learning to be performed with the quantized (i.e. discrete) values by enabling gradients to pass through to the continuous latents

$$\hat{L} = {\{ {\hat{I}}_{i} \}}_{i = 1}^{N}$$

—which, along with the shared decoder's parameters D, are learnable during training. Post-training, the continuous latents \hat{L} are quantized to provide the quantized latents

$$L = {\{ {l}_{i} \}}_{i = 1}^{N} .$$

In at least one embodiment, the quantized latents L are entropy coded to provide for further compression. Entropy coding can be efficiently implemented through the use of the quantized latents

$$L = {\{ {l}_{i} \}}_{i = 1}^{N} .$$

In at least one embodiment, the combination of quantized integer latents, shared linear decoders, and entropy coding demonstrated a 10× compression without quality degradation.

FIG. 3F illustrates the use of quantized integer latents and a shared linear decoder to generate floating point residual values, as well as the use of continuous surrogates for the quantized integer latents during training. Full-precision Gaussian residuals (i.e. floating point residuals) for N 3D Gaussians are represented as the product of N quantized integer latents and a shared linear decoder (i.e. floating point decoder). During training, the quantized integer latents are learned via the use of continuous approximations thereof (i.e. continuous surrogates), which are rounded during the forward pass and to which gradients flow in the backward pass via the straight through estimator.

After the Gaussian residuals have been represented via the sparsity framework (for the position residuals) and the quantization framework (for the remaining residuals), machine learning techniques are employed, at 114, to learn (i) the gates, (ii) the full-precision position residuals, (iii) the quantized latents, and (iv) the codebooks (i.e. the shared compact decoders). Specifically, for each image in the multi-view frame for time step t, renderings are generated in a forward pass (each rendering being a reconstructed image corresponding to a unique viewpoint from which a respective image of the multi-view frame for time step t was captured), a loss—which compares the renderings with corresponding images of the multi-view frame for time step t—is computed, gradients of the computed loss are backpropagated to the learnable parameters (i.e. the gate parameters, the full precision position residuals, the quantized latents, and the decoder parameters), and the learnable parameters are updated based on the backpropagated gradients. During each forward pass, the renderings are generated using previously computed Gaussian attributes for time-step t−1 and learnable Gaussian residuals for time-step t. To facilitate the generation of such renderings, the method 100 maintains, for each iteration of encoding process 104, a 3D representation of the scene for time step t−1 (e.g. by receiving said 3D representation from 116 of a prior iteration of the encoding process 104) in the form of a set of 3D Gaussians having attributes [symbol] ₜ₋₁. In at least one embodiment, densification is additionally performed at 114 to add new Gaussians for modeling new or finer scene content. In this manner, new 3D Gaussians can be added to the representation of the scene at any time step t, allowing the representation to be optimized in areas where more detail is needed. In at least one embodiment, a first rendering corresponding to a first image of the multi-view frame is used to optimize the learnable Gaussian residuals for time-step t for a first training epoch, and one or more additional renderings corresponding to one or more additional images of the multi-view frame are used to optimize the learnable Gaussian residuals for time-step t for one or more additional training epochs. In at least one embodiment, training is performed with only a subset of the images of the multi-view frame, and at least one image of the multi-view frame is reserved as a test image.

In at least one embodiment, at 114, gate parameters α and position residuals Lₚ are learned for position attributes, and quantized latents L_{c} and decoder parameters D_{c} (i.e. {L_{c}, D_{c}|c∈{q, s, o, h}}) are learned for all remaining attributes by minimizing a total loss function Lₜₒₜₐₗ=L+λ_{reg}L_{reg}, where L is a reconstruction loss representative of reconstruction quality (which compares a rendering R( [symbol] ) to an input image [symbol] the multi-view frame for time step t), L_{reg} is a regularization loss representative of memory/bandwidth requirements for saving/streaming the FVV, and λ_{reg} is a hyperparameter that controls tradeoffs between reconstruction quality and memory/bandwidth requirements. In at least one embodiment, L is the same reconstruction loss used for generating the canonical representation at time step t=0, e.g. L combines a D-SSIM loss (i.e. the structural dissimilarity loss derived from the structural similarity index (SSIM)) and L₁ loss with a hyperparameter λ: L=ΔL_{D-SSIM}+(1−λ)L₁. In at least one embodiment, L_{reg} is the regularization loss described above for encouraging L₀ sparsity in the gates gᵢ, e.g.

$${L}_{req} = {\sum }_{i = 1}^{N} {p}_{i} = {\sum }_{i = 1}^{N} Sigmoid ( log {α}_{i} - τ log \frac{- {γ}_{0}}{{γ}_{1}} ) .$$

By contemporaneously quantizing the non-position residuals while learning the various parameters of the Gaussian attributes/residuals, the method 100 simultaneously provides high compression while maintaining quality—as compared to alternative techniques that rely on post-training compression (which often have degraded quality).

Following the learning of the gate variables, position residuals, quantized latents, and codebooks at 114, method 100 transmits, at 118, sparse positions residuals (e.g. in the form of a sparse matrix) and quantized non-position residuals (e.g. in the form of, for each of rotation (qᵢ), scale (sᵢ), opacity (oᵢ), and color (hᵢ), a matrix containing the quantized latents and a matrix representing the shared linear decoder) to a client device. In addition, method 100 generates a 3D representation for time step t by updating the 3D representation for time-step t−1 using the sparse positions residuals and the quantized non-position residuals learned at 114. The 3D representation for time step t is then used as the 3D representation for time-step t−1 during a next iteration of the encoding process 104.

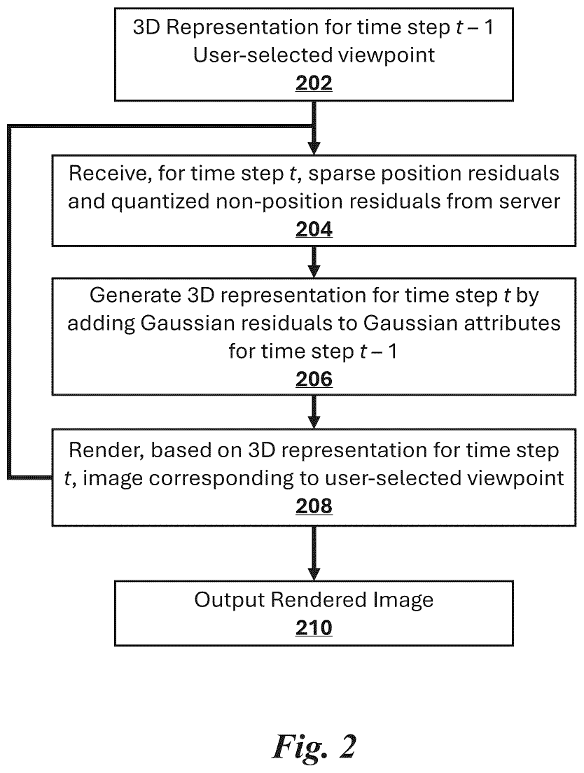

FIG. 2 is a flow diagram illustrating a method for rendering a free-viewpoint video (FVV) at a client device. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. Furthermore, persons of ordinary skill in the art will understand that any system that performs method 200 is within the scope and spirit of embodiments of the present disclosure.

Method 200 begins, at 202, by receiving or generating a 3D representation of a scene corresponding to time step t−1 and a user-selected viewpoint from which to observe the scene. The 3D representation of the scene corresponding to time step t−1 is in the form of a set of 3D Gaussians having attributes [symbol] ₜ₋₁. The set of 3D Gaussians can be received directly from a server (the canonical representation generated at 102 of method 100 may be transmitted directly to a client device and received by the client device) or can be reconstructed by the client device based on a prior 3D representation (e.g. corresponding to time step t−2 and Gaussian residuals received directly from the server (e.g. as transmitted by a server at 118 of method 100) for time step t−1). At 204, the client device receives, for time step t, Gaussian residuals [symbol] ₜ in the form of sparse positions residuals (e.g. in the form of a sparse matrix) and quantized non-position residuals (e.g. in the form of, for each of rotation (qᵢ), scale (sᵢ), opacity (oᵢ), and color (hᵢ), a matrix containing the quantized latents and a matrix representing the shared linear decoder). At 206, the client device generates an updated 3D representation for time step t by using the Gaussian residuals [symbol] ₜ received at 204 to update the Gaussian attributes [symbol] ₜ₋₁ of the 3D representation of the scene corresponding to time step t−1, thereby generating a 3D representation in the form of a set of 3D Gaussians having attributes [symbol] ₜ= [symbol] ₜ₋₁+ [symbol] ₜ.

At 208, the client device renders (e.g. via rasterization) an image of the scene at time t corresponding to the user-selected viewpoint. In at least one embodiment, for a 2D view of the scene corresponding to a user-selected viewpoint with intrinsic matrix K and viewing transform W, the 2D mean and covariance are p′ᵢ=Π(pᵢ; K, W) and

$${\sum }_{i}^{′} = JW {\sum }_{i} {W}^{T} {J}^{T} ,$$

where Π(⋅) denotes the perspective projection and J is the Jacobian of the affine approximation of the projective transform. The image color c at pixel location x is obtained by blending N depth-sorted 3D Gaussians with their view-dependent RGB color value cᵢ computed from hᵢ:

$$\hat{c} ( x ) = {\sum }_{i = 1}^{N} {c}_{i} {α}_{i} {\prod }_{j = 1}^{i - 1} ( 1 - {α}_{j} ) ,$$

where:

$${α}_{i} = {0}_{i} \cdot exp ( - \frac{1}{2} {( x - {p}_{i}^{′} )}^{T} {\sum }_{i}^{′ - 1} ( x - {p}_{i}^{′} ) ) ,$$

where αᵢ is the conic opacity of Gaussian i at pixel location x multiplied by the Gaussian opacity oᵢ. Method 200 then provides the image rendered at 208 as output and returns to 204 where a set of residuals for a subsequent time step are received.

FIG. 3A is a block diagram illustrating an example system 310, according to an embodiment, for serving a free-viewpoint video (FVV) to a client device in real time. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, the elements described therein (e.g. the modules) are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the framework of FIG. 3A is within the scope and spirit of embodiments of the present disclosure.

The system 310 includes initialization module 312, position residual sparsity module 314, attribute residual quantization module 316, and scene reconstruction module 318. Initialization module 312 is configured to differentiate static and dynamic Gaussians for gate initialization and adaptive masked training. In at least one embodiment, initialization module is configured to perform step 110 of method 100. Position residual sparsity module 314 is configured to represent position residuals via learnable gate variables and learnable position residuals. In at least one embodiment, position residual sparsity module 314 is configured to perform step 108 of method 100. Attribute residual quantization module 316 is configured to represent attribute residuals via learnable quantized latents and learnable codebooks. In at least one embodiment, attribute residual quantization module 316 is configured to perform step 112 of method 100. Scene reconstruction module 318 is configured to receive a set of 3D Gaussians representing a scene at time step t−1, to learn gate variables, position residuals, quantized latents, and codebooks for time step t, thereby providing set of spare position residuals and quantized attribute residuals for time step t. Scene reconstruction module 318 is further configured to generate a 3D representation of the scene at time step t by adding the residuals for time step t to the Gaussian attributes for time step t−1. In at least one embodiment, scene reconstruction module 318 is configured to perform steps 106, 114, and 116 of method 100.

More illustrative information will now be set forth regarding various optional architectures and features with which the foregoing methods and systems may be implemented, per the desires of the user. It should be strongly noted that the following information is set forth for illustrative purposes and should not be construed as limiting in any manner. Any of the following features may be optionally incorporated with or without the exclusion of other features described.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

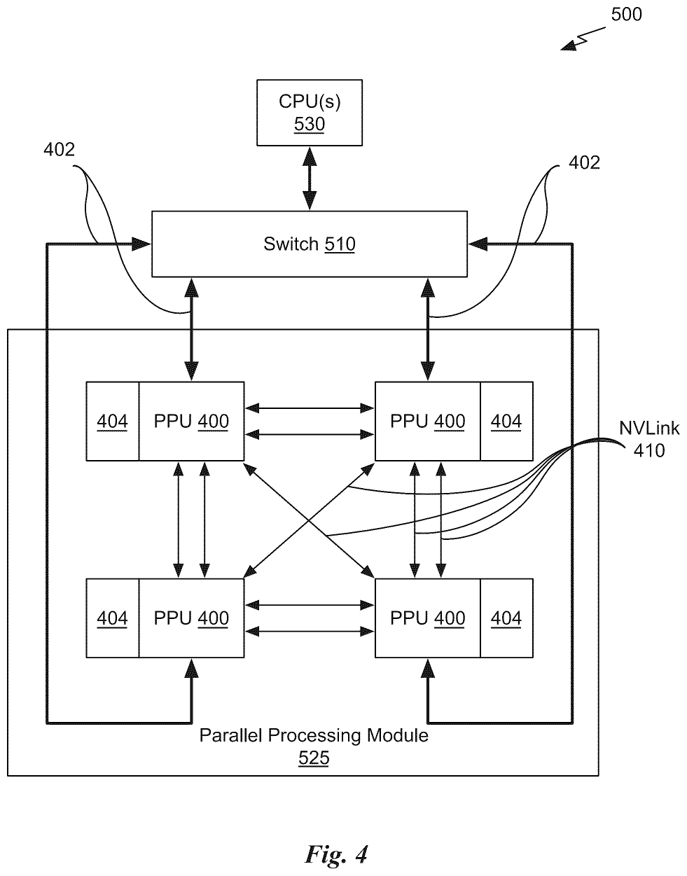

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

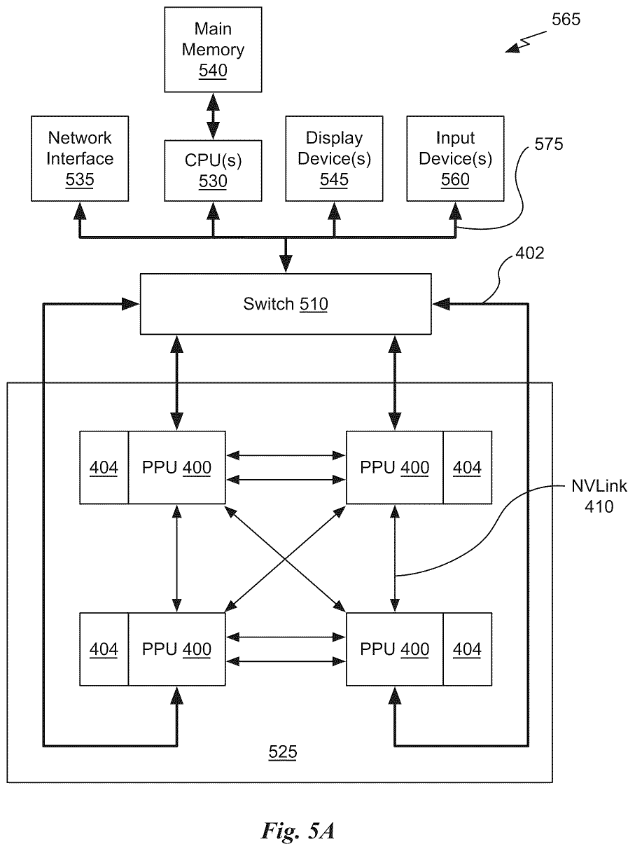

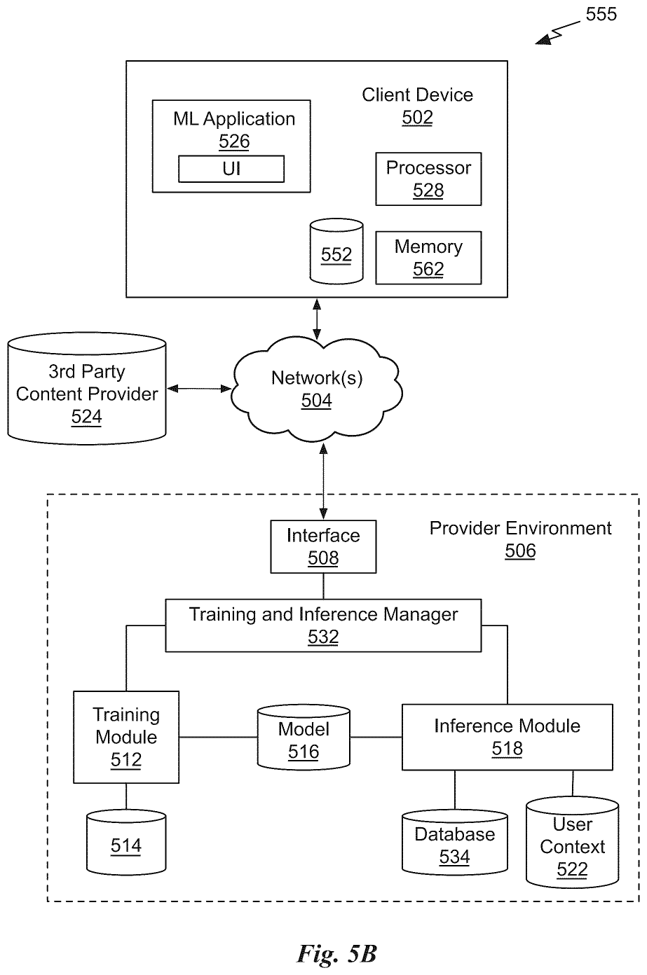

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Example Streaming System

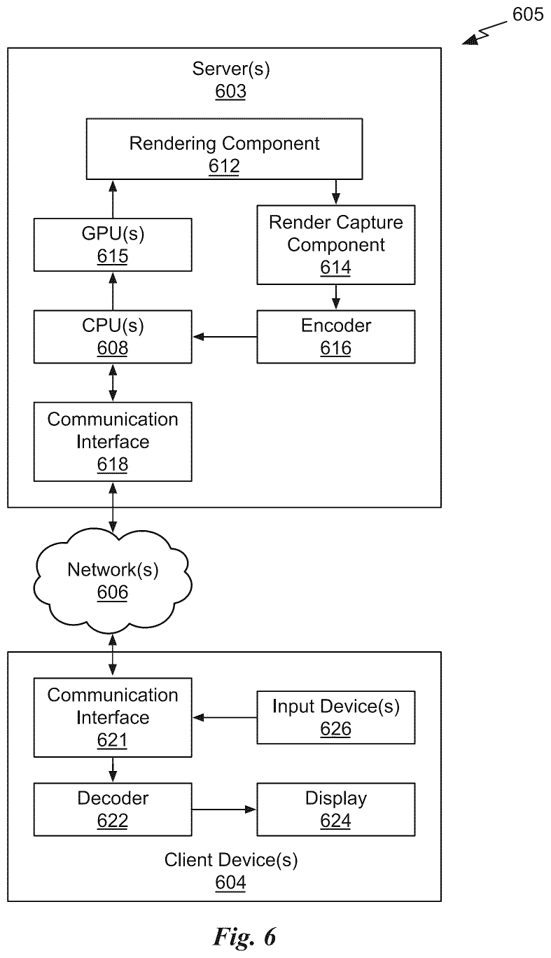

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for encoding a free-viewpoint video (FVV), the method comprising:
receiving, as input, a first multi-view frame of a scene corresponding to a first time;
generating, based on the first multi-view frame, a plurality of three-dimensional (3D) Gaussians that collectively represent the scene at the first time, wherein each 3D Gaussian includes a position attribute and one or more non-position attributes;
receiving, as further input, a second multi-view frame of the scene corresponding to a second time; and
determining, for each 3D Gaussian of the plurality of 3D Gaussians, a position residual and one or more non-position residuals, the determining comprising:
modeling the position residuals using a sparsity framework,
modeling the non-position residuals using a quantization framework, and
learning the position residuals and the non-position residuals using machine learning techniques.

2. The method according to claim 1, wherein modeling the position residuals using the sparsity framework comprises representing each position residual as a product of a learnable gate and a learnable full-precision position residual.

3. The method according to claim 2, wherein modeling the position residuals using the sparsity framework further comprises initializing parameters of each learnable gate based on a score vector computed, at least in part, from a gradient of a reconstruction loss with respect to a position of a corresponding Gaussian at the second time and a gradient of a reconstruction loss with respect to a position of the corresponding Gaussian at the first time.

4. The method according to claim 1, wherein modeling the non-position residuals using the quantization framework comprises representing each non-position residual as a product of a learnable integer latent and a learnable codebook.

5. The method according to claim 4, wherein the one or more non-position attributes comprise: a rotation attribute, a scale attribute, an opacity attribute, and a color attribute,
wherein the one or more non-position residuals comprise: a rotation residual, a scale residual, an opacity residual, and a color residual, and
wherein each respective rotation residual is modeled as a product of a corresponding respective rotation integer latent and a common rotation codebook, each respective scale residual is modeled as a product of a corresponding respective scale integer latent and a common scale codebook, each respective opacity residual is modeled as a product of a corresponding respective opacity integer latent and a common opacity codebook, and each respective color residual is modeled as a product of a corresponding respective color integer latent and a common color codebook.

6. The method according to claim 1, wherein the learning the position residuals and the non-position residuals using machine learning techniques comprises:
rendering, during a forward pass, an output image corresponding to a viewpoint from which a respective image of the second multi-view frame was captured, the rendering being performed using the position attributes, the non-position attributes, learnable position residuals, and learnable non-position residuals,
computing a loss by comparing the output image to the respective image of the second multi-view frame,
calculating, during a backward pass, gradients of the computed loss with respect to the learnable position residuals and the learnable non-position residuals, and
updating the learnable position residuals and the learnable non-position residuals based on the calculated gradients.

7. The method according to claim 6, wherein the loss includes a reconstruction loss and a regularization loss, wherein the reconstruction loss measures a difference between the output image and the respective image of the second multi-view frame, and wherein the regularization loss decreases as the sparsity of the learnable position residuals increases.

8. The method according to claim 6, wherein the learning the position residuals and the non-position residuals further comprises defining, for the respective image of the second multi-view frame, static and dynamic regions, and
wherein the rendering the output image is performed only for the dynamic regions of the respective image of the second multi-view frame.

9. The method according to claim 1, further comprising generating, based on the first multi-view frame, a point cloud, wherein the point cloud is generated using a structure-from-motion algorithm and enhanced using depth map provided via monocular depth estimation.

10. A system for encoding a free-viewpoint video (FVV), the system comprising:
processing circuitry configured to:
receive, as input, a first multi-view frame of a scene corresponding to a first time;
generate, based on the first multi-view frame, a plurality of three-dimensional (3D) Gaussians that collectively represent the scene at the first time, wherein each 3D Gaussian includes a position attribute and one or more non-position attributes,
receive, as further input, a second multi-view frame of the scene corresponding to a second time, and
determine, for each 3D Gaussian of the plurality of 3D Gaussians, a position residual and one or more non-position residuals, the processing circuitry being configured to determine the position residuals and the non-position residuals by:
modeling the position residuals using a sparsity framework,
modeling the non-position residuals using a quantization framework, and
learning the position residuals and the non-position residuals using machine learning techniques; and
one or more memories configured to store the first multi-view frame, the plurality of 3D Gaussians, the second multi-view frame, and the position residuals and the non-position residuals.

11. The system according to claim 10, the processing circuitry being configured to model the position residuals using the sparsity framework by representing each position residual as a product of a learnable gate and a learnable full-precision position residual.

12. The system according to claim 11, the processing circuitry being configured to model the position residuals using the sparsity framework by further initializing parameters of each learnable gate based on a score vector computed, at least in part, from a gradient of a reconstruction loss with respect to a position of a corresponding Gaussian at the second time and a gradient of a reconstruction loss with respect to a position of the corresponding Gaussian at the first time.

13. The system according to claim 10, the processing circuitry being configured to model the non-position residuals using the quantization framework by representing each non-position residual as a product of a learnable integer latent and a learnable codebook.

14. The system according to claim 13, wherein the one or more non-position attributes comprise: a rotation attribute, a scale attribute, an opacity attribute, and a color attribute,
wherein the one or more non-position residuals comprise: a rotation residual, a scale residual, an opacity residual, and a color residual, and
wherein the processing circuitry is configured to:
model each respective rotation residual as a product of a corresponding respective rotation integer latent and a common rotation codebook,
model each respective scale residual as a product of a corresponding respective scale integer latent and a common scale codebook,
model each respective opacity residual as a product of a corresponding respective opacity integer latent and a common opacity codebook, and
model each respective color residual as a product of a corresponding respective color integer latent and a common color codebook.

15. The system according to claim 10, the processing circuitry being configured to learn the position residuals and the non-position residuals using machine learning techniques by:
rendering, during a forward pass, an output image corresponding to a viewpoint from which a respective image of the second multi-view frame was captured, the rendering being performed using the position attributes, the non-position attributes, learnable position residuals, and learnable non-position residuals,
computing a loss by comparing the output image to the respective image of the second multi-view frame,
calculating, during a backward pass, gradients of the computed loss with respect to the learnable position residuals and the learnable non-position residuals, and
updating the learnable position residuals and the learnable non-position residuals based on the calculated gradients.

16. The system according to claim 15, wherein the loss includes a reconstruction loss and a regularization loss, wherein the reconstruction loss measures a difference between the output image and the respective image of the second multi-view frame, and wherein the regularization loss decreases as the sparsity of the learnable position residuals increases.

17. The system according to claim 16, the processing circuitry being further configured to learn the position residuals and the non-position residuals by defining, for the respective image of the second multi-view frame, static and dynamic regions, wherein the rendering the output image is performed only for the dynamic regions of the respective image of the second multi-view frame.

18. The system according to claim 10, the processing circuitry being further configured to generate, based on the first multi-view frame, a point cloud, wherein the point cloud is generated using a structure-from-motion algorithm and enhanced using depth map provided via monocular depth estimation.

19. A non-transitory computer-readable media storing processor-executable instructions for encoding a free-viewpoint video (FVV) that, when executed by processing circuitry, cause the processing circuitry to perform a method comprising:
receiving, as input, a first multi-view frame of a scene corresponding to a first time;
generating, based on the first multi-view frame, a plurality of three-dimensional (3D) Gaussians that collectively represent the scene at the first time, wherein each 3D Gaussian includes a position attribute and one or more non-position attributes;
receiving, as further input, a second multi-view frame of the scene corresponding to a second time; and
determining, for each 3D Gaussian of the plurality of 3D Gaussians, a position residual and one or more non-position residuals, the determining comprising:
modeling the position residuals using a sparsity framework,
modeling the non-position residuals using a quantization framework, and
learning the position residuals and the non-position residuals using machine learning techniques.

20. The non-transitory computer-readable media according to claim 19, wherein the learning the position residuals and the non-position residuals using machine learning techniques comprises:
rendering, during a forward pass, an output image corresponding to a viewpoint from which a respective image of the second multi-view frame was captured, the rendering being performed using the position attributes, the non-position attributes, learnable position residuals, and learnable non-position residuals,
computing a loss by comparing the output image to the respective image of the second multi-view frame,
calculating, during a backward pass, gradients of the computed loss with respect to the learnable position residuals and the learnable non-position residuals, and
updating the learnable position residuals and the learnable non-position residuals based on the calculated gradients.
